(19) United States
(12) Patent Application Publication
(10) Pub. No.: US 2019/0094063 A1
(43) Pub. Date: Mar. 28, 2019

(54) SCALE CALIBRATION DEVICE AND METHOD OF USE

(71) Applicant: Pelstar, LLC, McCook, IL (US)

(72) Inventors: Ken Harris, McCook, IL (US); Brian C. Skinner, McCook, IL (US)

(21) Appl. No.: 16/145,276

(22) Filed: Sep. 28, 2018

Related U.S. Application Data
(60) Provisional application No. 62/564,861, filed on Sep. 28, 2017.

(51) Int. Cl. G01G 23/01; G01G 19/44

(52) U.S. Cl. CPC G01G 23/01; G01G 19/44

(57) ABSTRACT

A scale calibration device and method of use. The device may include a base supportable on and movable along a surface to a location. The base further includes a base surface for supporting a scale to be calibrated proximate the location. The device includes a frame assembly coupled to the base and operable to support a force-supplying mechanism in a position over the base surface.

### RELATED APPLICATION

The present application claims priority to U.S. Provisional Patent Application No. 62/564,861, filed Sep. 28, 2017, the entire contents of which is hereby incorporated by reference.

### FIELD

The present invention relates to calibration devices and methods of calibrating devices, such as scales and, more particularly, medical scales.

### SUMMARY

Scales to weigh people come in a variety of sizes. Typically, those used in the medical industry are larger and more robust than those for home use. It is important for scales, especially medical scales, to be accurately calibrated.

Current devices and methods for calibrating such scales are heavy and cumbersome, typically requiring standard weights weighing hundreds of pounds. Storage, movement and use of these calibration devices can be difficult and labor- and time-intensive.

In some independent embodiments, the present invention may provide a portable, force application device for the calibration, accuracy testing, etc., of a scale, such as a professional medical scale. The device may eliminate or minimize the need to transport and manipulate large certified test weights to accomplish such tasks. In some embodiments, the device may employ test software operating on a computing device, such as a tablet, laptop, personal computer, desktop, terminal, etc., to monitor an applied force, to log data, and/or to output such data (e.g., provide reports).

The device may be used to calibrate medical scales in lieu of certified test weights. For example, the National Institute of Standards and Technology (NIST) recommends that a 1000 lb. capacity scale be calibrated at a minimum weight of 300 lbs. The device may improve calibration, accuracy testing, etc. of scales, compared to manipulating test weights. The device may be capable of single load point calibration as well as multiple load point calibration.

The device may also be capable of checking the accuracy of medical scales across their entire rated load range. For example, the force applied by the device can be compared to an indicated weight on the scale S to develop a scale performance curve. A review of this data can provide useful information on accuracy of the scale and/or help diagnose the nature of any inaccuracies of the scale.

The device may make scale testing practical, as the device can eliminate the prohibitive amount of effort and/or transportation of up to 1000 pounds (lbs.) or more of certified test weights. These constraints have typically resulted in an industry practice that is tolerant of not reviewing scale performance across the entire operating load range of the scale.

In one independent aspect, a scale calibration device may generally include a base supportable on and movable along a surface to a location, the base including a base surface for supporting a scale to be calibrated proximate the location; and a frame assembly connected to the base and operable to support a force-applying mechanism in a position over the base surface, the force-applying mechanism being operable to apply a force to the scale supported on the base surface.

In another independent aspect, a method of calibrating a scale may be provided. The method may generally include moving to a location a calibration device, the calibration device including a base with a base surface and a frame assembly connected to the base; supporting a scale to be calibrated proximate the location on the base surface; and applying a force to the scale supported on the base surface to calibrate the scale, applying including applying a force with a force-applying mechanism supported on the frame over the base surface.

In yet another independent aspect, a calibration device may generally include a base supportable on and movable along a surface to a location, the base including a base surface for supporting a scale to be calibrated proximate the location; a frame assembly connected to the base, the frame assembly having an end; and a force-applying mechanism supported on the end of the frame assembly in a position over the base surface, the force applying mechanism being operable to apply a force to the scale supported on the base surface to calibrate the scale.

Independent features and independent advantages of the invention may become apparent to those skilled in the art upon review of the following detailed description, claims and drawings.

### BRIEF DESCRIPTION OF THE DRAWINGS

FIG. 1 is a perspective view of a scale calibration device.

FIG. 2 is a front view of the device of FIG. 1.

FIG. 3 is a side view of the device of FIG. 1.

FIG. 4 is a top view of the device of FIG. 1.

FIG. 5 is a photo of a front perspective view a scale calibration device.

FIG. 6 is a photo of a side view of the device of FIG. 5.

FIG. 7 is a photo of a side view of the device of FIG. 5, illustrated supporting a scale to be calibrated.

FIG. 8 is a photo of a perspective view of an alternative scale calibration device.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

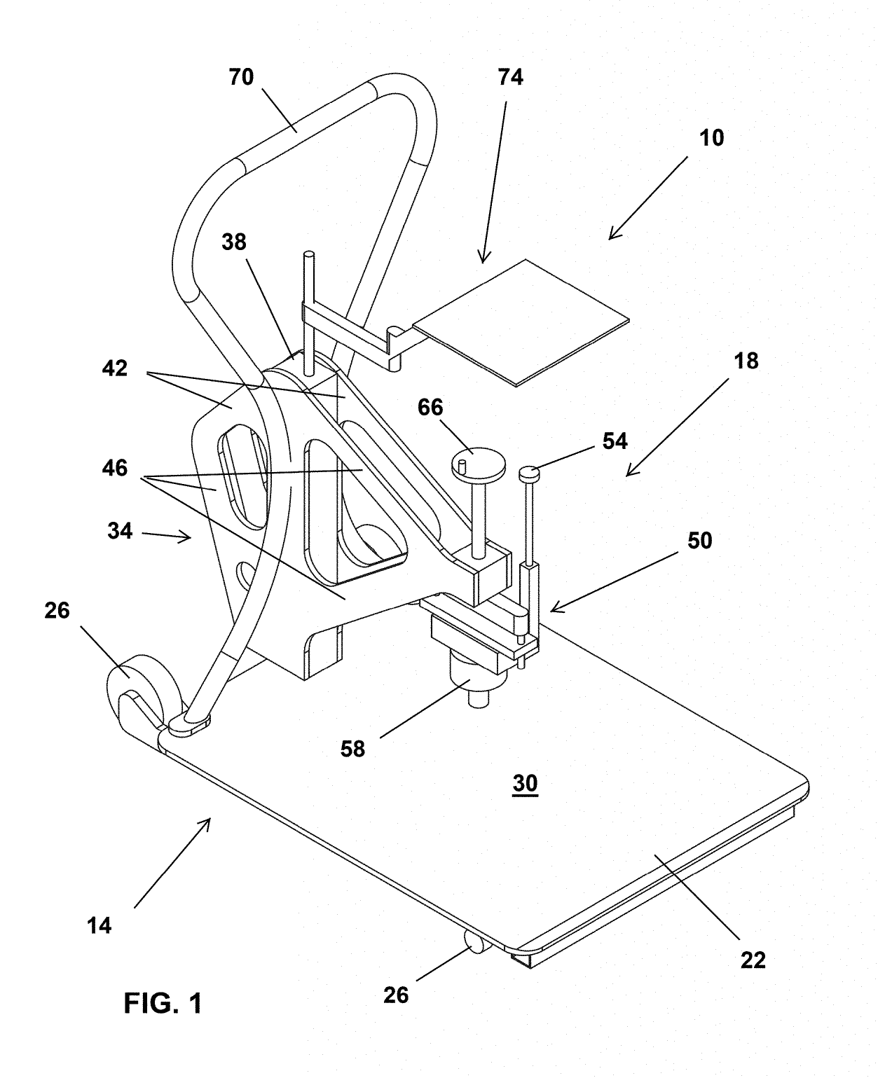

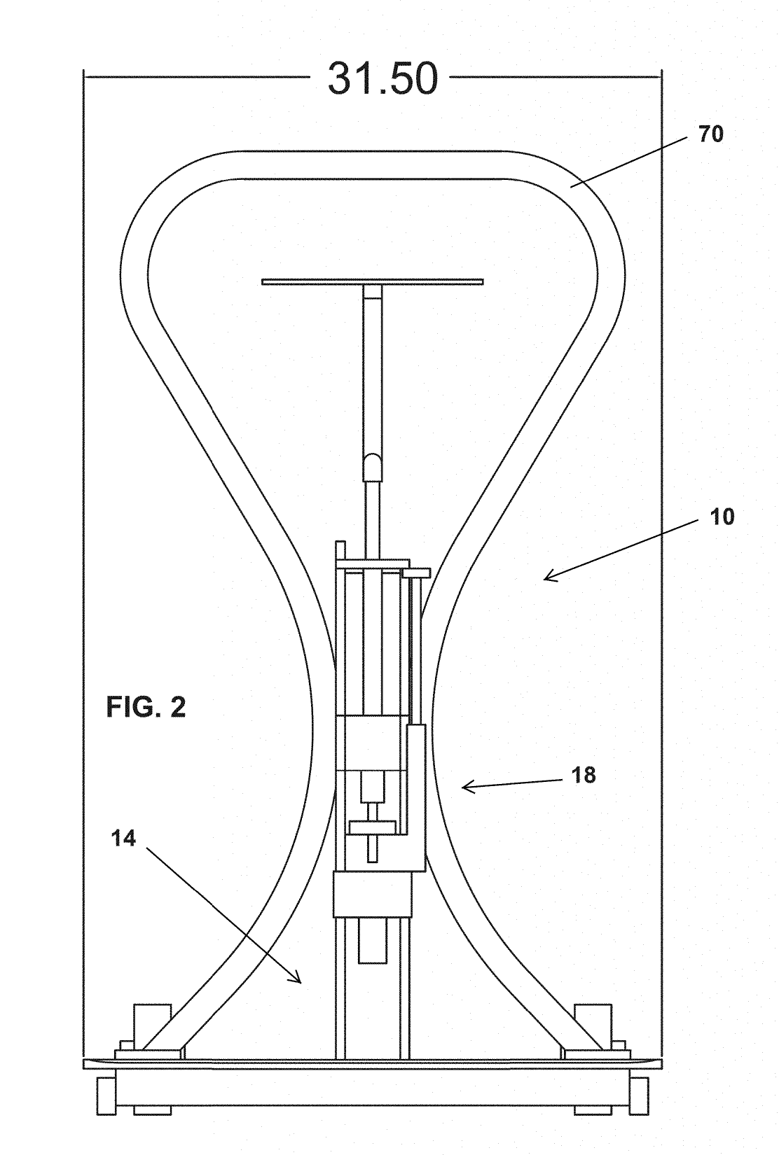

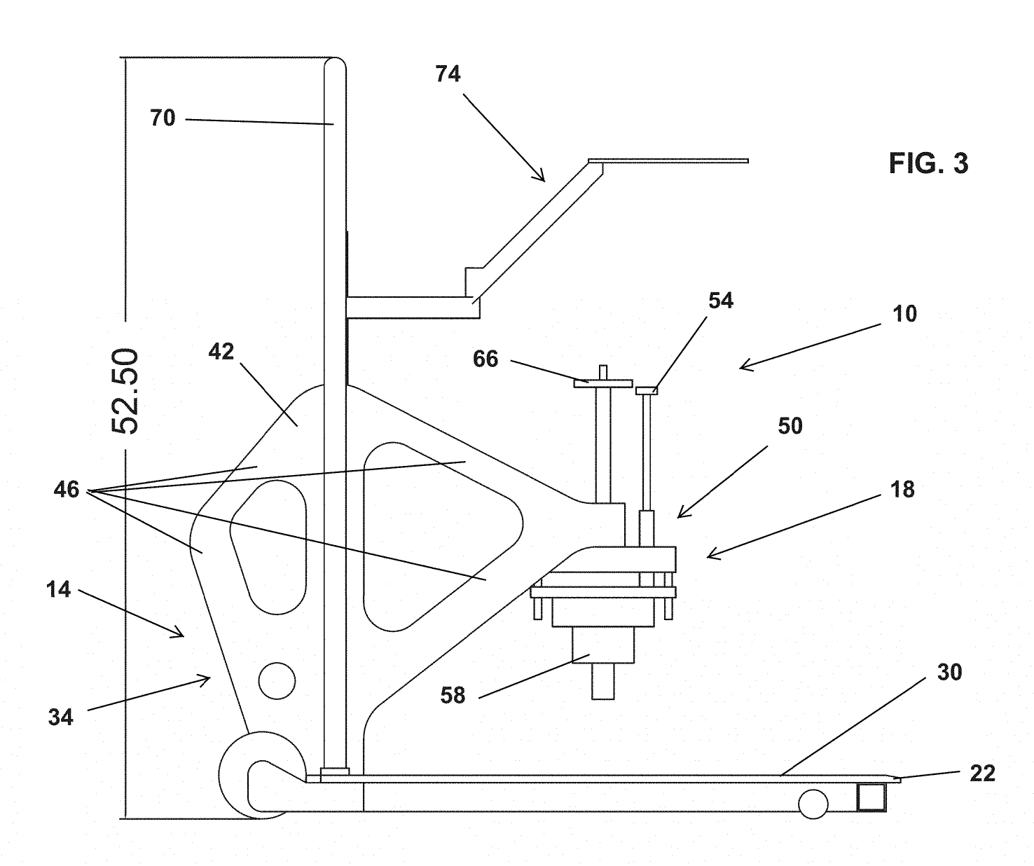

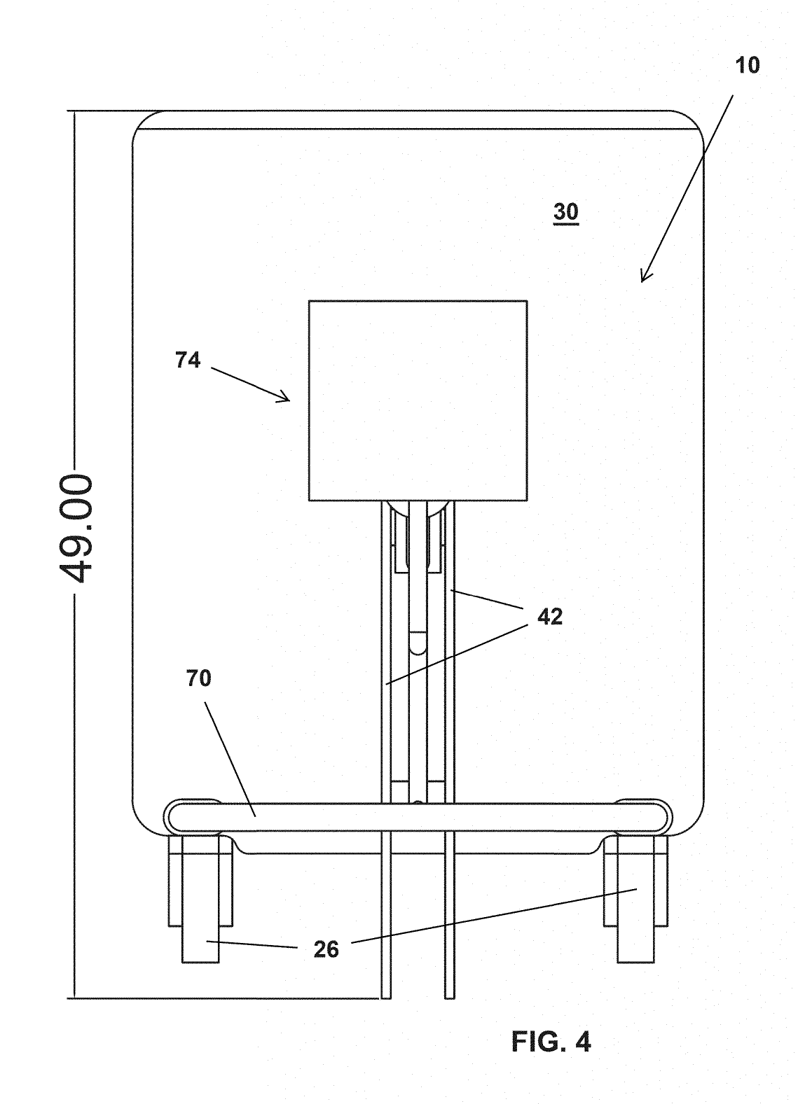

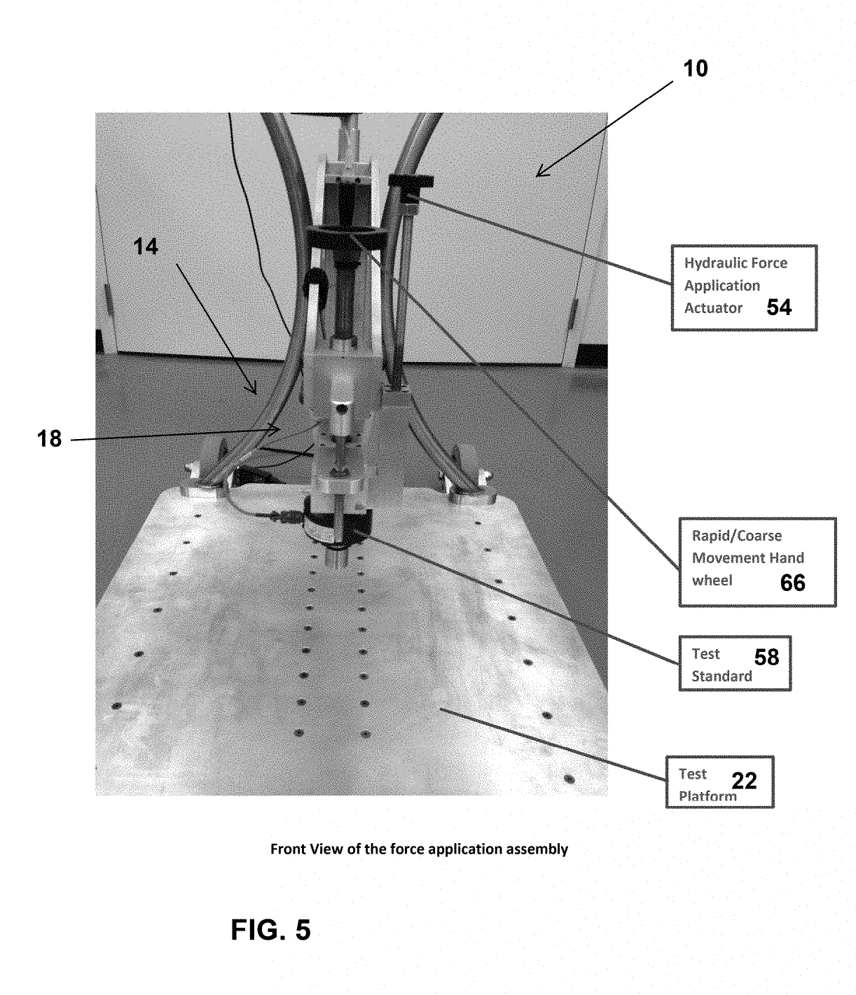

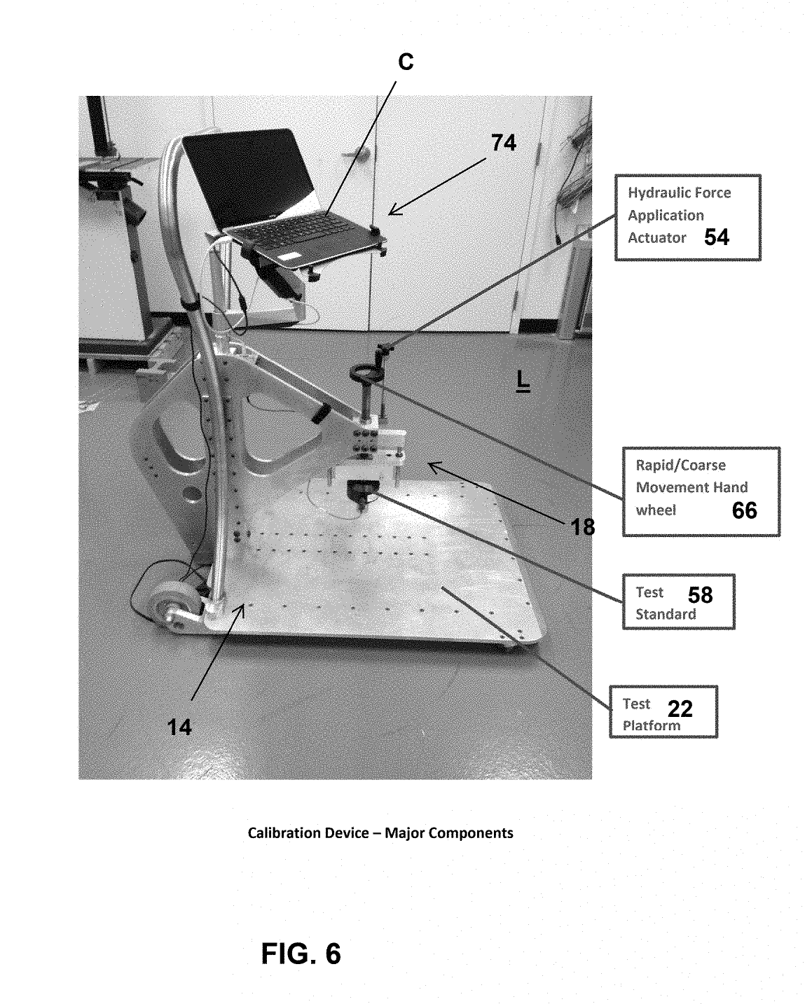

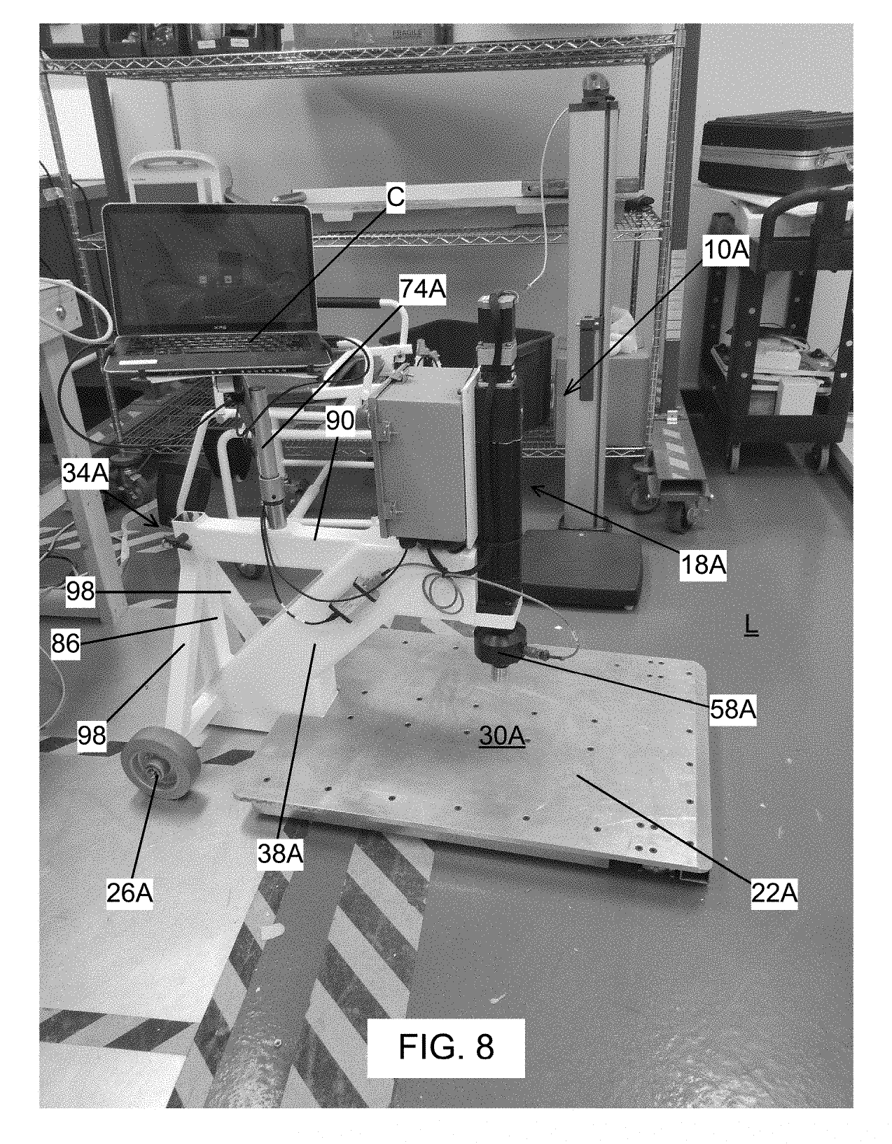

FIGS. 1-7 illustrate a portable, force application device 10 for the calibration, accuracy testing, etc. of a scale S, such as a professional medical scale. FIG. 8 illustrates an alternative design of a portable, force application device 10 for the calibration, accuracy testing, etc. of a scale S such as a professional medical scale. In some embodiments, the device 10 may employ test software operating on a computing device C, such as a tablet, laptop, personal computer, desktop, terminal, etc., to monitor an applied force, to log data, and/or to output such data (e.g., provide reports).

Referring to FIGS. 1-4, the device 10 includes a support assembly 14, operable to support the scale S to be calibrated, and a force application assembly 18, operable to apply a force to calibrate the scale S. The support assembly 14 includes a platform or base 22 supportable on and movable along a surface (e.g., on one or more wheels 26) to a location L, such as a doctor's office, other health/medical facility, health club/gym, a user's home, etc., for calibration of a scale S at the location L. The base 22 has an upper surface 30 on which the scale S is supportable.

A frame assembly 34 is attached to the base 22 and includes a post 38 fixed to a rear edge of the base 22 supporting side plates 42 extending over the base surface 30. The frame assembly 34 supports the force applying assembly 18 over the base surface 30. The base 22 and the frame assembly 34 are constructed to resist reaction forces resulting from support and operation of the force apply assembly 18 and to limit deflection of the force applying assembly 18 to less than about 0.02 inch (in.) during calibration (e.g., under a load up to about 1,200 lbs.).

The frame assembly 34 may be fixed to and non-removable from the base 22 or may be removable from the base 22. In constructions in which the frame assembly 34 is removable from the base 22, the device 10 includes a connecting mechanism (not shown; e.g., a positive connecting mechanism (removable pins, fasteners, etc.), a frictional connecting mechanism (a clamp), etc.) to substantially rigidly connect the frame assembly 34 and the base 22 while limiting deflection of the force applying assembly 18.

The device 10 may also include an indicator mechanism (not shown) operable to indicate connection of the frame assembly 34 and the base 22 in an orientation for use. The indicator mechanism may include a visual indicator (e.g., alignable indicator members on the frame assembly 34 and the base 22).

A sensor assembly (not shown) may sense the relative orientation of the frame assembly 34 and the base 22 and communicate sensed information to the computing device C which may provide the indication. In other constructions, the computing device C may use the sensed information to adjust calibration based on the sensed orientation of the components (e.g., the frame assembly 34, the base 22, the force applying assembly 18, etc.).

The base 22 and the frame assembly 34 are arranged generally in a C-shape and are constructed to optimize support of the force applying assembly 18 generally and during use and size and weight of the device 10. For example, the illustrated side plates 42 include a web structure with web portions 46 constructed to resist reaction forces resulting from support and operation of the force applying assembly 18 and material removed to decrease weight.

The force applying assembly 18 simulates a dead weight by applying known amounts of force. The force applying assembly 18 may include any suitable force applying mechanism, such as, for example, a load cell, a piston-cylinder assembly, a hydraulic cylinder, a pneumatic cylinder, a screw jack, a screw lift, an electromagnet, etc.

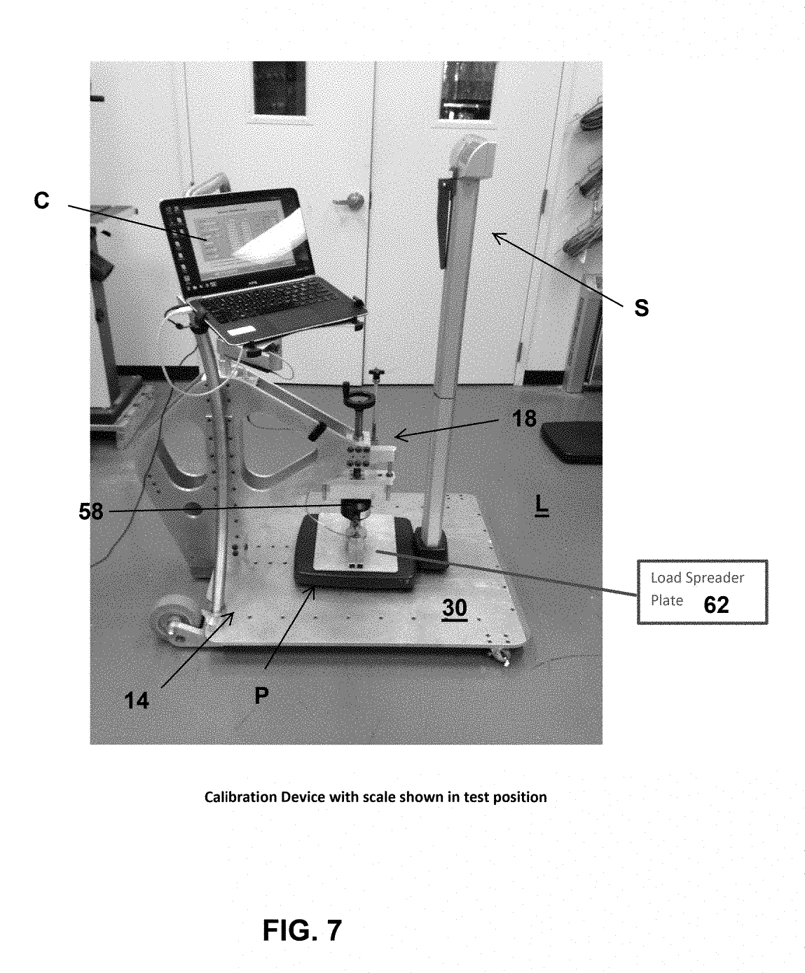

The illustrated force applying assembly 18 includes a hydraulic cylinder assembly 50. An actuator 54 is operable to control the hydraulic cylinder assembly 50 to apply a force. A test standard 58 is supported at the end of the assembly 50 to apply the force to the scale S through a load spreader plate 62 (see FIG. 7) engaging the scale S.

An adjustment mechanism (e.g., a hand wheel 66) is operable to position the test standard 58. The adjustment mechanism may provide rapid or coarse adjustment (e.g., axial sliding along threaded rod) to quickly position the test standard 58 as well as fine adjustment (e.g., threaded adjustment).

The force applying assembly 18 is rigidly connected to but removable from the frame assembly 34. The rigid connections of the frame assembly 34 may prevent or limit inaccuracy in the applied force. Reaction forces from the force applying assembly 18 may be equally transferred to the base 26 through the frame assembly 34.

A handle 70 is connected to the base 22 and the frame assembly 34 and is engageable by a user for transport and positioning of the device 10. The handle 70 is removable from the base 22 and the frame assembly 34. A work support assembly 74 extends from the post 38 and is operable to support the computing device C in a position for the user to operate the device 10. The work support assembly 74 includes a support shaft 78 connected to the post 38 and a support member 82 on the support shaft 78. The support member 78 is operable to support the computing device C or other materials (e.g., a medical chart, a notebook, medical instruments, etc.) and is adjustable to be positioned for access by the user. The work support assembly 74 is detachable from the frame assembly 34.

The computing device C may be operable to control the operation of the force applying assembly 18, display or otherwise output data, such as a calibration weight being applied, perform other functions, such as, for example, monitoring the calibration/testing operation, communicating with other devices, logging data, maintaining data, providing reports, controlling the movement of the device 10.

The device 10 may have of any suitable dimensions to be transportable to and around a location (e.g., through a standard doorway) and to support and perform functions on a variety of scales. In certain embodiments, the device 10 has a height of approximately 52.25 in., a width of approximately 31.5 in, and a length of approximately 49.5 in. While being able to provide the minimum calibration weight of at least 300 lbs., the illustrated device 10 has a weight less than or equal to about 300 lbs. or even less than or equal to about 250 lbs.

The device 10 is moved to and positioned in the location for calibration of a scale S. Operation of the device 10 to calibrate or test a scale S may begin with starting the computing device C and the associated device program. The test standard 58 is configured in the appropriate window of the program, and the test series is selected (or configured). When these steps are complete, the device 10 is allowed to “warm-up” for approximately 10 minutes.

The scale S to be tested or calibrated is positioned on surface 30 of the base 22 such that the center of the weighing platform P of the scale S is directly below the test standard 58. The scale S is turned on. The load spreader plate 62 is placed on the scale platform P with the load target directly below the force application point of the test standard 58. The scale S is “zeroed” to account for the weight of the load spreader plate 62. The rapid/coarse movement hand wheel 66 is used to lower the test standard force application point to contact with the load spreader target, resulting in a small amount of force being applied to the scale S.

The actual test force is applied to scale S by turning the actuator 54 (the small hand wheel) to establish the target level of force (as a proxy for a test weight) on the scale S. Data that relates the indicated weight of the test standard 58 to the indicated weight for the scale S is collected. The data is stored and analyzed, output, etc. (e.g., along with collection of at a later time). The device 10 may be operated to calibrate and test the scale S across a load range (e.g., across the entire rated load range of the scale S).

In the illustrated construction, the actuator 54 of the hydraulic cylinder assembly 50 is operated manually to operate the device 10 and calibrate the scale S. In other constructions, the force applying assembly 18 may be controlled by the computing device C to apply forces to the scale S. The program may select a weight/force to be applied, and the force applying assembly 18 may be adjusted to apply the selected force. The operation is continued through calibration of the scale S.

FIG. 8 illustrates an alternative construction of a scale calibration device 10A. The device 10A is similar to the device 10 described above and shown in FIGS. 1-7, and common elements have the same reference number “A”.

In the device 10A, the base 22A and the frame assembly 34A are arranged generally in a C-shape and are constructed to resist reaction forces resulting from support and operation of the force apply assembly 18A and to limit deflection of the force applying assembly 18A (again, to less than about 0.02 in. during calibration under a load up to about 1,200 lbs.). The illustrated frame assembly 34A includes an angled post 38A connected to the base 22A. A generally vertical first member 86 extends from a rear portion of the post 38A, and a generally horizontal second member 90 connects the upper portion of the first member 86 and the post 38A. The handle (not shown) is removably connectable to the first member 86.

A wheel support 94 extends from opposite lateral sides of the post 38A, and reinforcing members 98 are connected between the outer ends of the wheel support 94 and the first member 86. The rear wheels 26A are positioned on the wheel support 94 at a width no more than the width of a standard truck ramp (e.g., no more than about 24 in.) while still providing a steady and stable support during transport.

To facilitate transportation of the device 10A, at least a portion of the frame assembly 34A may be removable from the base 22A. For example, the post 38A may be disconnectable from the base 22A so that the base 22A and the frame assembly 34A are movable separately and independently. The frame assembly 34A may be subdivided—the post 38A may be disconnectable from the first and second members 86, 90, the reinforcing members 98, etc. The device 10A includes connecting structure to substantially rigidly connect the base 22A and the frame assembly 34A and to limit deflection in use.

The independent embodiments described above and illustrated in the figures are presented by way of example only and are not intended as a limitation upon the concepts and principles of the present invention. As such, it will be that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

One or more independent features and/or independent advantages may be set forth in the following claims:

What is claimed is:

1. A device comprising:
a base supportable on and movable along a surface to a location, the base including a base surface for supporting a scale to be calibrated proximate the location; and
a frame assembly connected to the base and operable to support a force-applying mechanism in a position over the base surface, the force-applying mechanism being operable to apply a force to the scale supported on the base surface.

2. The device of claim 1, further including the force-applying mechanism supported on the frame assembly.

3. The device of claim 2, further comprising an adjustment mechanism operable to position a test standard on the force-applying mechanism.

4. The device of claim 3, wherein the adjustment mechanism includes a hand wheel.

5. The device of claim 1, wherein the frame assembly and the base are arranged generally in a C-shape.

6. The device of claim 1, wherein the frame assembly is non-removable from the base.

7. The device of claim 1, further comprising a work support assembly including a post coupled to the frame assembly and a support member connected to the post.

8. The device of claim 7, wherein the work support assembly and the post are removable from the frame assembly.

9. The device of claim 1, wherein the frame assembly includes a generally vertical first beam connected to the base and a generally horizontal second beam extending from the first beam.

10. The device of claim 9, wherein the frame includes one or more support beams between the first beam and the second beam.

11. The device of claim 1, further comprising one or more wheels connected to the base and operable to move the base along the surface.

12. The device of claim 1, wherein the frame assembly includes a first portion removably coupled to a second portion.

13. The device of claim 1, further comprising a handle connected to one of the base and the frame assembly and engageable to position the device relative to the location.

14. The device of claim 13, wherein the handle is removable from the one of the base and the frame assembly.

15. A method of calibrating a scale, the method comprising:
moving to a location a calibration device, the calibration device including a base with a base surface and a frame assembly connected to the base;
supporting a scale to be calibrated proximate the location on the base surface; and
applying a force to the scale supported on the base surface to calibrate the scale, applying including applying a force with a force-applying mechanism supported on the frame assembly over the base surface.

16. The method of claim 15, further comprising removing the frame assembly from the base, and wherein moving includes moving the frame assembly and the base separately.

17. The method of claim 15, further comprising adjusting an adjustment mechanism to lower a test standard to contact a load spreader target.

18. A device comprising:
a base supportable on and movable along a surface to a location, the base including a base surface for supporting a scale to be calibrated proximate the location;
a frame assembly connected to the base, the frame assembly having an end; and
a force-applying mechanism supported on the end of the frame in a position over the base surface, the force applying mechanism being operable to apply a force to the scale supported on the base surface to calibrate the scale.

19. The device of claim 18, wherein the frame assembly is non-removably connected to the base.

20. The device of claim 18, further comprising a handle removably connected to one of the base and the frame assembly and engageable by a user to position the device relative to the location.
